(19) United States
(12) Patent Application Publication
(10) Pub. No.: US 2021/0007927 A1
(43) Pub. Date: Jan. 14, 2021

(54) FULL BODY WRAP MASSAGE CHAIR

(71) Applicant: LURACO, INC., Arlington, TX (US)

(72) Inventors: KEVIN LE, RICHLAND HILLS, TX (US); THANH LE, ARLINGTON, TX (US); VARAD GOKHALE, IRVING, TX (US)

(73) Assignee: LURACO, INC., ARLINGTON, TX (US)

(21) Appl. No.: 16/505,371

(22) Filed: Jul. 8, 2019

(51) Int. Cl. A61H 15/00; A61H 23/02

(52) U.S. Cl. CPC A61H 15/0078; A61H 23/02; A61H 2201/1657; A61H 2201/0103; A61H 2201/0149

(57) ABSTRACT

A massage chair includes a seat and a backrest configured to support a user. A pair of side panels extend upward from opposing sides of the seat so as to form an armrest. A pivoting arm is coupled to at least one of the pair of side panels and the backrest and is configured to selectively rotate between a first position and a second position. The pivoting arm extends over a portion of the massage chair in the second position and is automatically biased between the first position and the second position. A roller mechanism is included within the pivoting arm to selectively agitate a surface of the pivoting arm so as to induce a massage effect. The roller mechanism is controlled via a remote control and can operate between a plurality of settings including an on/off setting, a rotational speed setting, a motion setting, and a heat setting.

### CLAIM OF PRIORITY

This application claims the benefit of and is a Continuation-In-Part of U.S. patent application Ser. No. 14/103,840, filed 11 Dec. 2013. The information contained therein is hereby incorporated by reference.

### BACKGROUND

### 1. Field of the Invention

The present invention generally relates to massage chairs and massage devices and apparatuses for massage chairs. More specifically, the present invention is directed to a massage chair that provides one or more pivoting arms that extend over a front portion of a user within the massage chair.

### 2. Description of Related Art

Massage chairs and massage devices and apparatuses for massage chairs are known in the art.

Most or all of the patents, published patent applications, and/or nonpatent publications directed at massage chairs and massage devices and apparatuses for massage chairs disclose massage benefits or effects being provided to a back body area of a user. At least one discloses massage benefits or effects being provided from the neck to the shoulder, back, and hips.

The present invention overcomes one or more of the shortcomings of the above described massage chairs and massage devices and apparatuses for massage chairs. The Applicant is unaware of inventions or patents, taken either singly or in combination, which are seen to describe the present invention as claimed.

Although strides have been made to massage chairs, shortcomings remain.

### SUMMARY OF THE INVENTION

The present invention is directed to a massage chair including a seat and a backrest configured to support a user. A pair of side panels extend upward from opposing sides of the seat so as to form an armrest. A pivoting arm is coupled to at least one of the pair of side panels and is configured to selectively rotate between a first position and a second position. The pivoting arm extends over the seat in the second position. A roller mechanism is included within the pivoting arm to selectively agitate a surface of the pivoting arm so as to induce a massage effect.

The pivoting arm is configured to automatically rotate into the first position. This may be done by configuring the pivoting arm to store potential energy when transitioning into the second position. The pivoting arm may include a spring for example.

Another object of the present application is control the operation of the pivoting arm between the first and second positions. In one embodiment, a user is able to pull down the pivoting arm so that it contacts a portion of the body for a massage. In another embodiment, the massage chair is configured to automatically regulate the position of the pivoting arm.

A positioning member may be used to selectively adjust the position of the pivoting arm from the first position to the second position. The positioning member may include an airbag and work off of air pressure. The pressure of the air in the airbag may dictate the position of the pivoting arm. Potential energy within the pivoting arm raises the pivoting arm as pressure is released from the positioning member.

A further object of the present application is to permit one or more pivoting arms on the massage chair. A pivoting arm may be coupled to at least one of the pair of side panels adjacent the seat. Likewise, a pivoting arm may be coupled to the backrest of the massage chair. Furthermore, pivoting arms may be coupled to either or both of the pair of side panels and the backrest as well as even a footrest or leg portion of the massage chair.

It is another object of the present application to induce a massage effect upon a lower surface of one or more pivoting arms that acts to massage the front portion of a user's body. The pivoting arms may include a roller mechanism to operate adjacent the lower surface. The roller mechanism is controlled via a remote control and can operate between a plurality of settings including at least any of an on/off setting, a rotational speed setting, a motion setting, and a heat setting.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a massage apparatus for a massage chair according to the present invention;

FIG. 2 is a front view of the massage apparatus for a massage chair of FIG. 1;

FIG. 3 is a right side view of the massage apparatus for a massage chair of FIG. 1;

FIG. 4 is a perspective, front view of a massage device of the massage apparatus for a massage chair of FIG. 1;

FIG. 5 is a perspective, front and right side view of a massage device of the massage apparatus for a massage chair of FIG. 1;

FIG. 6 is a perspective, rear view of a massage device of the massage apparatus for a massage chair of FIG. 1;

FIG. 7 is a perspective, rear and right side view of a massage device of the massage apparatus for a massage chair of FIG. 1;

FIG. 8 is another perspective, rear and right side view of a massage device of the massage apparatus for a massage chair of FIG. 1;

FIG. 9 is a front side perspective view of an exemplary massage chair in accordance with the present application.

FIG. 10 is a front view of the massage chair of FIG. 9.

FIG. 11 is a chart of the massage chair of FIG. 9.

FIG. 12 is a perspective view of a roller mechanism in the massage chair of FIG. 9.

FIG. 13 is a top view of the roller mechanism of FIG. 11.

FIGS. 14A-14C are views of an airbag in the massage chair of FIG. 9.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

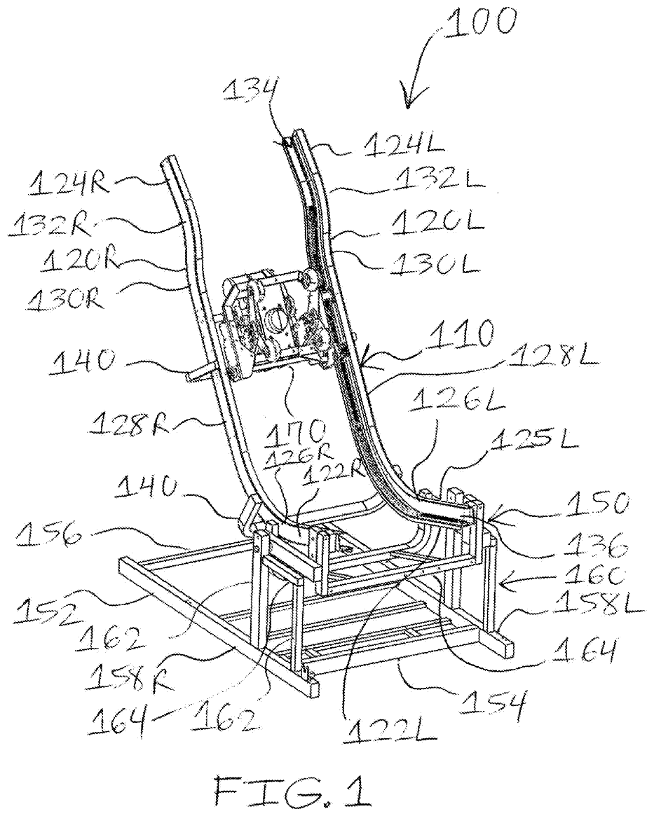

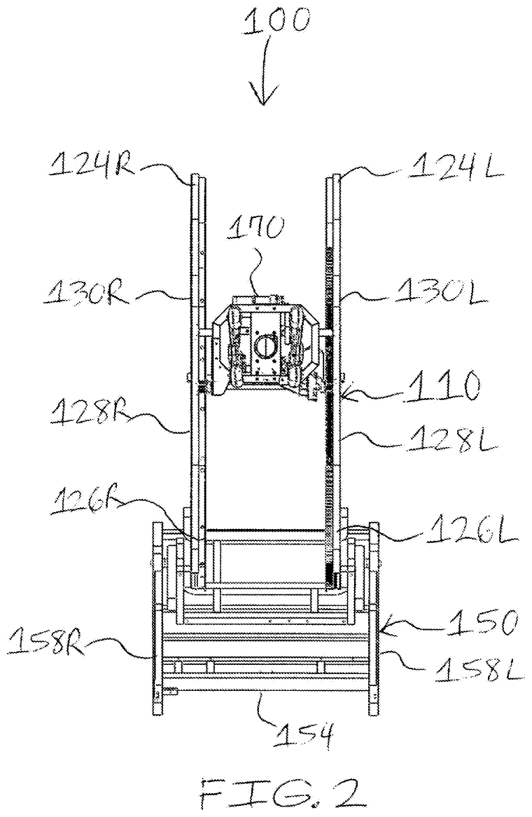

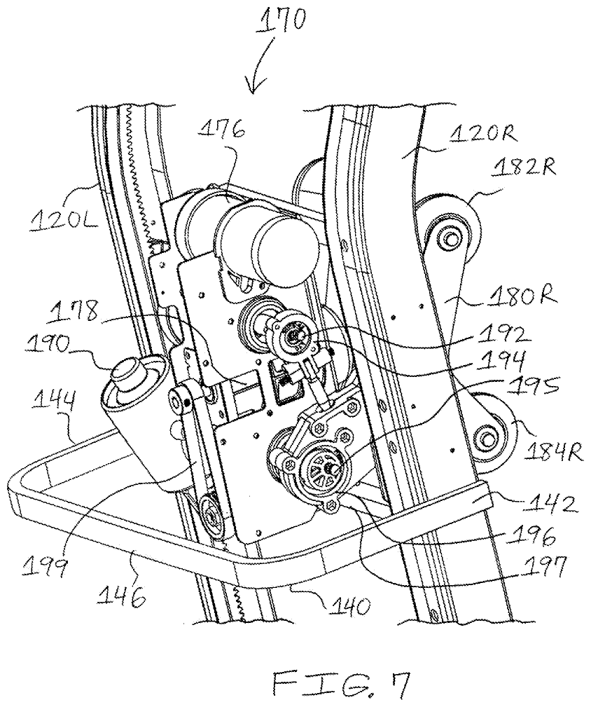

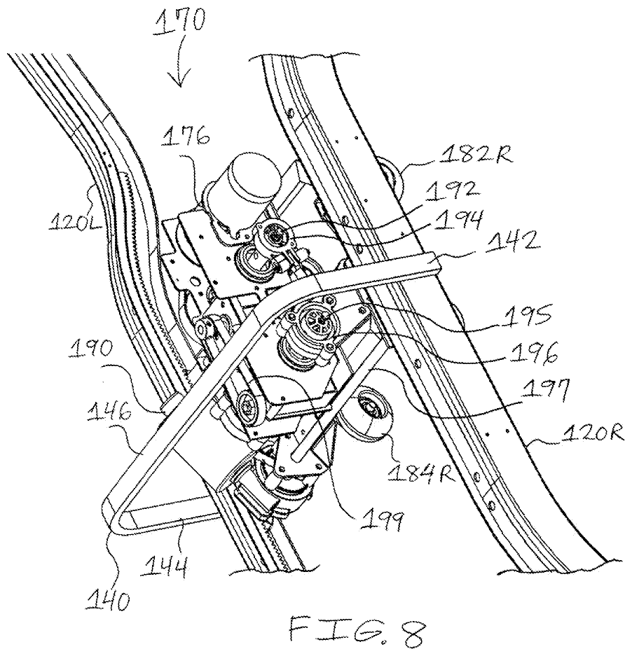

Referring to FIGS. 1-8, the present invention is directed to a massage apparatus 100 for a massage chair wherein massage benefits or effects are provided to a back body area, a bottom body area, and a thigh body area of a user (not shown). Massage benefits or effects may also be provided to a head and neck body area of the user. The massage apparatus 100 includes a frame 110 and a massage device 170.

As a non-limiting example and as best shown in FIGS. 1-3, the frame 110 includes a pair of opposing guide rails 120R, 120L, a plurality of guide rails stabilizing bars 140, and a base stand 150. The guide rails 120R, 120L are secured to the base stand 150, and are positioned generally above the base stand 150. The base stand 150 supports the weights of the guide rails 120R, 120L, massage device 170, and user (not shown) of the massage chair. The guide rails 120R, 120L are spaced apart to provide a balanced movement of massage device 170 along the pair of guide channels.

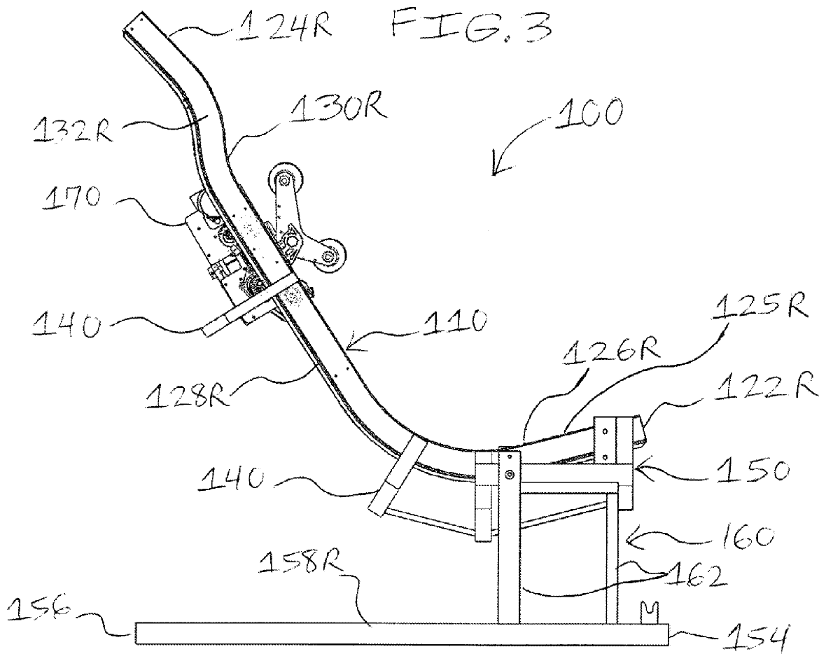

Preferably, the guide rails 120R, 120L are substantially similar or mirror images of one another. Each of the guide rails 120R, 120L includes a first end 122R, 122L, a second end 124R, 124L, a thigh body area portion 125R, 125L located adjacent the first end 122R, 122L, a seat or bottom body area portion 126R, 126L located adjacent the thigh body area portion 125R, 125L and away from the first end 122R, 122L, a back body area portion 128R, 128L extending upward from the bottom body area portion 126R, 126L, a head and neck body area portion 130R, 130L extending upward from the back body area portion 128R, 128L and located about the second end 124R, 124L, an outer side 132R, 132L, an inner side 134, and a guide channel 136 extending from the thigh body area portion 125R, 125L to the back body area portion 128R, 128L, preferably to the head and neck body area portion 130R, 130L, and running along the inner side 134 of the guide rail 120R, 120L. The guide channel 136 includes gear teeth 138 for engaging with at least one gear member from the massage device 170 when the massage device 170 moves upward and downward in a generally vertical direction from the first end 122R, 122L toward the second end 124R, 124L of the guide rail 120R, 120L and vice versa, respectively. Preferably, each of the guide rails 120R, 120L has a generally “L-shaped” configuration. In this configuration, the lower portion of the “L” includes the thigh body area portion 125R, 125L and bottom body area portion 126R, 126L, and the upper portion of the “L” includes the back body area portion 128R, 128L and head and neck body area portion 130R, 130L. As best shown in FIGS. 1 and 3, more preferably, each of the guide rails 120R, 120L has a reclining “L-shaped” configuration.

It is understood that guide rails 120R, 120L may extend past the thighs and further down the leg, thereby making the general shape in the form of an “S”. In such configuration each of the guide rails 120R, 120L may be made from a singular continuous member to eliminate seams and joints which cause disruption and jolting in the movement of device 170. Alternatively, guide rails 120R, 120L may be made from multiple members to form its shape, however, any and all joints will be flush such that the ends of each member will fully abut the neighboring member. The idea is to eliminate any and all gaps in channel 136. This is especially important at joints that are within a curved portion of the guide rails or define the beginning or end of a curved portion of the guide rails. Maintaining a full flush abutting at the joints of the members in curved portions is paramount to maintaining a smooth transition of device 170 as it moves along the entire length of guide rails 120R, 120L.

The plurality of guide rails stabilizing bars 140 help to stabilize the positioning of the guide rails 120R, 120L relative to one another. Each of the guide rails stabilizing bars 140 has a first end 142, a second end 144, and a body portion 146 extending from the first end 142 to the second end 144. Preferably, each of the guide rails stabilizing bars 140 has a generally “U-shaped” configuration. The guide rails stabilizing bars 140 are secured at predetermined locations along the outer sides 132R, 132L of the guide rails 120R, 120L.

The base stand 150 includes a base 152 and a guide rails support structure 160. The base 152 includes a first or front end 154, a second or rear end 156, and a pair of opposing sides 158R, 158L. The guide rails support structure 160 is secured about the front end 154 of the base 152, and is positioned above the base 152. The guide rails support structure 160 includes a plurality of vertical bars or members 162 and a plurality of horizontal bars or members 164. The plurality of vertical bars 162 extend upward from the pair of opposing sides 158R, 158L of the base 152, and, along with the plurality of horizontal bars 164, form a support frame with a “square-shaped” or “rectangular-shaped” box configuration.

Since the base stand 150 supports the weights of the guide rails 120R, 120L, massage device 170, and user of the massage chair, the base stand 150 is preferably made or manufactured of a strong material, such as, but not limited to, steel, metal, wood, hard plastic, any combination of the listed materials, and any material or combination of materials known to one of ordinary skill in the art. Also, the guide rails 120R, 120L may be made or manufactured of steel, metal, wood, plastic, any combination of the listed materials, and any material or combination of materials known to one of ordinary skill in the art.

The massage device 170 includes a power source, at least one massage element, and at least one gear member. The massage device 170 may be a conventional massage device or any applicable massage device that is known to one of ordinary skill in the art.

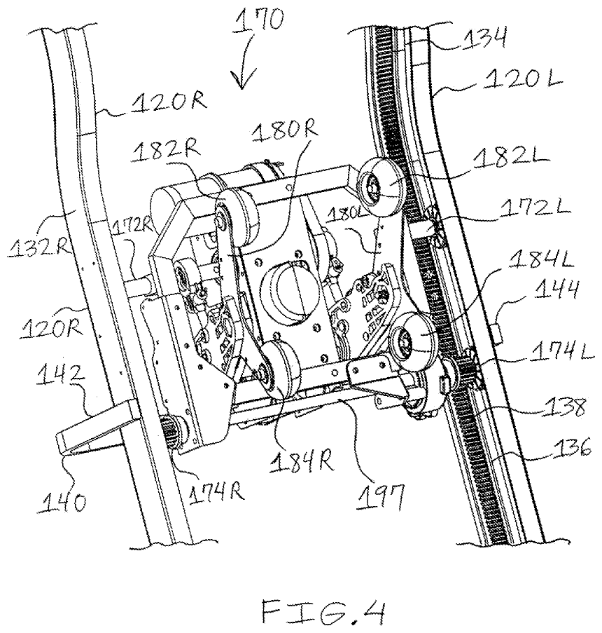

As a non-limiting example and as best shown in FIGS. 4-8, the massage device 170 includes a pair of massage device moving members 172R, 172L, a pair of gear members 174R,17 4L, a pair of massage arms 180R, 180L, a first motor 176, a second motor 178, a third motor 190, a rotation shaft 192 driven by the first motor 176, a pair of rotation to knocking translator members 194, a rotation shaft 195 driven by the second motor 178, a pair of rotation to kneading translator members 196, a rotation shaft 197 for vertical movement gears driving, a speed reduction belt 198 for the first motor 176, and a speed reduction belt 199 for the second motor 178.

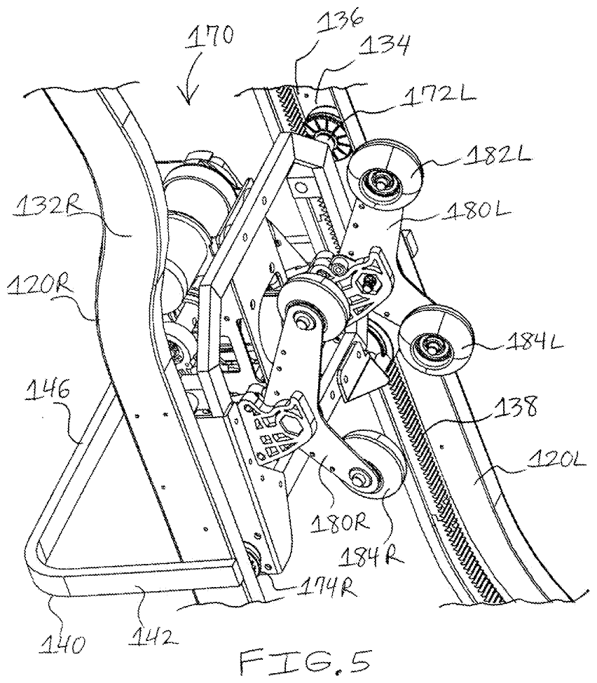

As best shown in FIGS. 4 and 5, each of the pair of massage device moving members 172R, 172L is positioned within a corresponding guide channel 136 of a guide rail 120R, 120L, and helps the massage device 170 move in a generally vertical direction along the guide channel 136.

As best shown in FIGS. 4 and 5, each of the pair of gear members 174R,17 4L is positioned within a corresponding guide channel 136 of a guide rail 120R, 120L, and engages with the teeth 138 located in the corresponding guide channel 136. Each gear tooth within curved portions of channel 136 have a tooth profile pointing in a direction toward a center of the curved section at that particular gear tooth. As noted above, guide rails 120R, 120L may be made from one or more members, and that any joints are to be fully abutted to ensure smooth operation of device 170. This same function and feature applies equally to teeth 138. The teeth 138 may be formed separate from that of guide rails 120R, 120L and subsequently secured thereto internally within the C-channel shaped channel 136 (i.e. on a plate secured with fasteners); or teeth 138 may be formed into the interior of channel 136. As seen in FIG. 5, a break line in the teeth 138 within channel 136 may show a representative example of the close interfacing and engagement at the joints of teeth 138, between various members of teeth 138, either at or distal from any joint in the guide rails.

As best shown in FIGS. 4-8, each of the pair of massage arms 180R, 180L includes a first or upper massage roller 182R, 182L and a second or lower massage roller 184R, 184L. Each of the pair of massage arms 180R, 180L can move vertically. As a non-limiting example, each of the pair of massage arms 180R, 180L may be able to move both vertically and laterally. The massage rollers 182R, 182L, 184R, 184L provide massage benefits or effects to a back body area, a bottom body area, and a thigh body area of the user when the massage device 170 is moved to, near or about that particular body area. The massage rollers 182R, 182L, 184R, 184L may also provide massage benefits or effects to a head and neck area of the user when the massage device 170 is moved to, near or about the head and neck area. It will be understood by one of ordinary skill in the art that the timing of the pattern of the raising and lowering may be varied on each roller 182R, 182L, 184R, 184L, such as by adjusting the degree of rotation of one or more of the following: rotation shaft 192 driven by the first motor 176, pair of rotation to knocking translator members 194, rotation shaft 195 driven by the second motor 178, pair of rotation to kneading translator members 196, speed reduction belt 198 for the first motor 176, and speed reduction belt 199 for the second motor 178. Also, it will be understood by one of ordinary skill in the art that the rate of speed of rotation as well as the direction of rotation of the rollers 182R, 182L, 184R, 184L may be adjusted by varying the motor speed or direction.

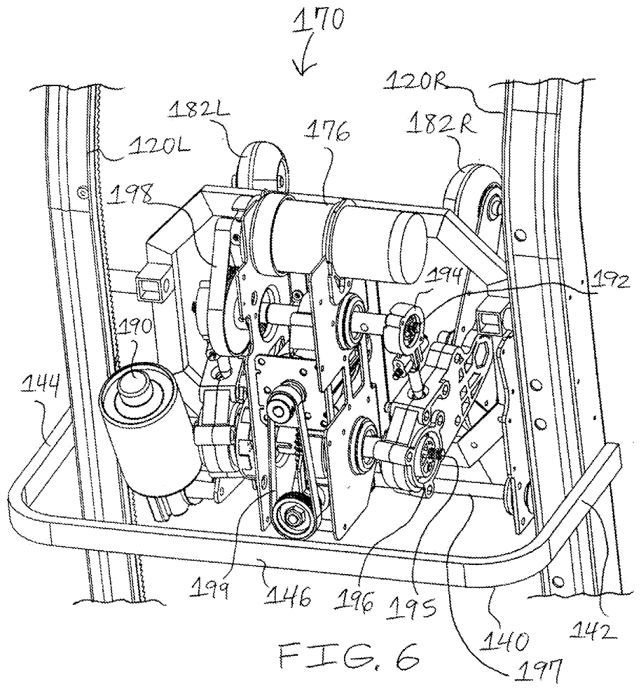

As best shown in FIGS. 6-8, the first and second motors 176, 178 provide power to the pair of massage arms 180R, 180L, respectively, while the third motor 190 provides power for the generally vertical movement of the massage device 170.

As best shown in FIGS. 6-8, the rotation shaft 192 driven by the first motor 176 causes the first massage arm 180R to be activated and to carry out its massage actions when this rotation shaft 192 is rotated.

As best shown in FIGS. 6-8, each of the pair of rotation to knocking translator members 194 assists the corresponding massage arm 180R, 180L and corresponding massage roller(s) 182R, 182L, 184R, 184L to carry out its knocking massage actions when the corresponding rotation shaft 192, 195 is rotated.

As best shown in FIGS. 6-8, the rotation shaft 195 driven by the second motor 178 causes the second massage arm 180L to be activated and to carry out its massage actions when this rotation shaft 195 is rotated.

As best shown in FIGS. 6-8, each of the pair of rotation to kneading translator members 196 assists the corresponding massage arm 180R, 180L and corresponding massage roller(s) 182R, 182L, 184R, 184L to carry out its kneading massage actions when the corresponding rotation shaft 192, 195 is rotated.

As best shown in FIGS. 6-8, the rotation shaft 197 for vertical movement gears driving causes the massage device 170 to move upward or downward when this rotation shaft 197 is rotated.

As best shown in FIG. 6, the speed reduction belt 198 for the first motor 176 adjusts the speed of the first massage arm 180R.

As best shown in FIGS. 6-8, the speed reduction belt 199 for the second motor 178 adjusts the speed of the second massage arm 180L.

When in use or in operation, the user (not shown) may activate the massage device 170 of the massage apparatus 100 for a massage chair by or via pushing, touching, using voice command for use on or with, using a mechanical or remote control for use on or with, or any other activation method known to one of ordinary skill in the art, an activation, start, control or command button, touch area, box or panel, or any other activation method or element known to one of ordinary skill in the art. Preferably, the user is able to control the generally vertical movement of the massage device 170 and massage rollers 182R, 182L, 184R, 184L upward and downward along the guide rails 120R, 120L such that the massage device 170 and massage rollers 182R, 182L, 184R, 184L are arm positioned about, near or at a desired body part area, such as the thighs, bottom, lower back, upper back, and head and neck, of the user so that desired body part area of the user can receive massage effects or benefits from the massage rollers 182R, 182L, 184R, 184L when desired. Preferably, the user is also able to control the timing, movement, etc. of the massage rollers 182R, 182L, 184R, 184L such that that the massage rollers 182R, 182L, 184R, 184L can provide different massage effects or benefits, such as knocking, kneading, etc., to the desired body part area of the user at a particular moment or time.

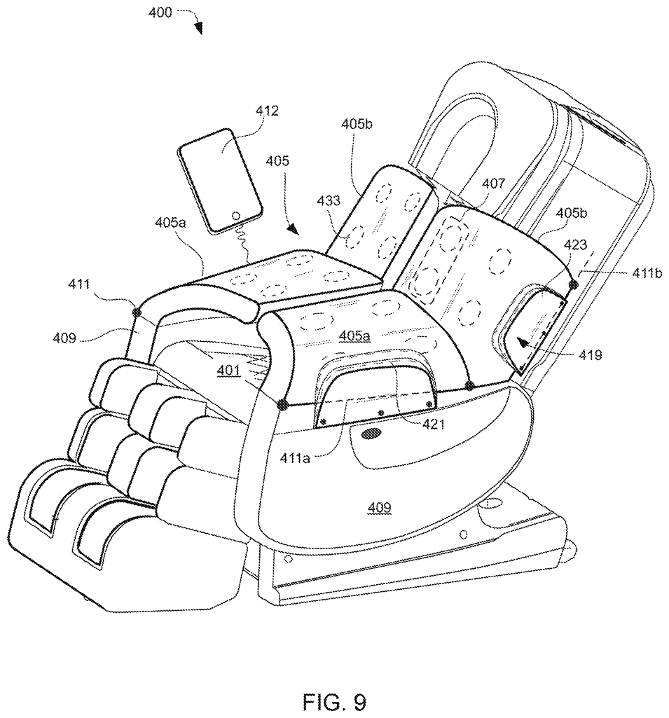

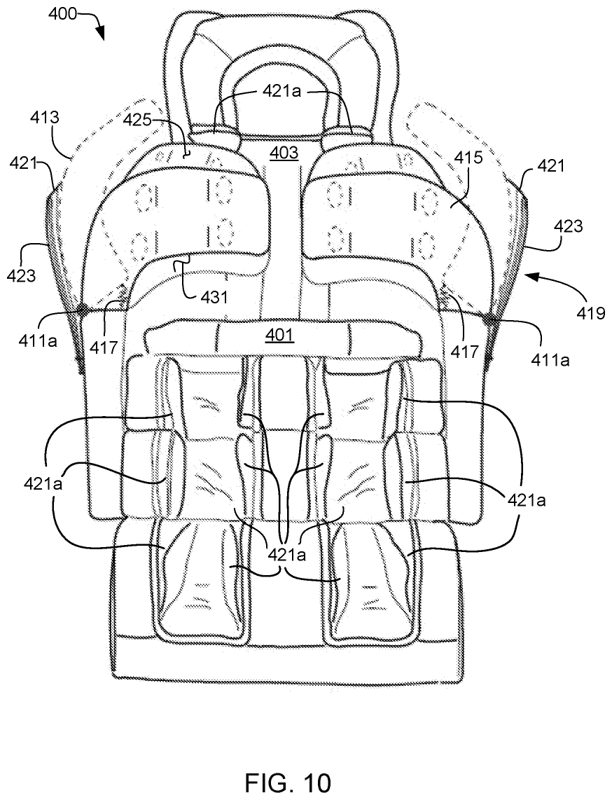

Referring now to FIGS. 9 and 10 in the drawings, an embodiment of a massage chair utilizing a massage apparatus is illustrated. Massage chair 400 may include any or all of the elements described previously, such as massage apparatus 100 in combination with frame 110 and massage device 170 in operation with frame 110 so as to operate from a neck portion to a lower leg portion of the massage chair. In addition to such features, massage chair 400 is particularly suited for providing the capability of massaging the front of a user or occupant. Whereas the prior discussion revolved around a method and apparatus of massaging a user from sides and a rear surface of the body, massage chair 400 is configured to permit massaging along a front surface of a user's body.

Massage chair 400 includes a seat 401, a backrest 403, a pivoting arm 405, and a roller mechanism 407. Seat 401 is adjacent seat or bottom body area portion 126R, 126L. A pair of side panels 409 extend upward along opposing sides of seat 401 and may be used as an armrest for a user. Backrest 403 extends upward from a rear side of seat 401. As seen in FIG. 9, a plurality of pivoting arms 405 are shown, namely pivoting arms 405a and 405b. Arms 405a and 405b are coupled to different portions of chair 400. Arms 405a are coupled to side panels 409 whereas arms 405b are coupled to backrest 403. Pivoting arms 405a and 405b may include airbag 421.

Although depicted as having pivoting arms 405 work as a pair from each side of chair 400, it is understood that each pair of opposing pivoting arms 405a and 405b may be configured instead to operate with a single pivoting arm at each portion of chair 400. For example, arms 405a may be replaced by a single arm that extends across seat 401. Likewise, in some embodiments, arms 405b may be replaced by a single arm that extends across backrest 403.

Referring now in particular to FIG. 10, a front view of massage chair 400 is illustrated wherein pivoting arms 405a are shown in different positions. In FIG. 10, pivoting arms 405b are not clearly shown in an effort to fully illustrate the movement of arms 405a and 405b. Description related to arms 405a will apply equally to that of arms 405b. Pivoting arms 405a and 405b are configured to pivot about an axis 411a and 411b respectively (see FIG. 9). This permits the arms to alternate between a first position 413 and a second position 415. In the first position 413 arm 405a is raised away from seat 401. In the second position 415, arm 405a is lowered so as to extend over a portion of seat 401. This movement applies equally with arms 405b and backrest 403.

In operation it is understood that the movements of arms 405a and 405b may be performed or regulated in different manners. For example, it is understood that arms 405a and 405b may be manually operated such that a user may manually pull down the arms to a set position over their body. In such an embodiment, the arms may be configured to have one or more set latching points to allow the user to select the desired position of the arm relative to their body. The release of the arms may be manual as well or controlled via an automated timer or remote control 412. Such arms may also be biased to automatically return to the first position when released.

In another embodiment, and as shown in the Figures, chair 400 may be configured to automatically control or regulate the position of the arms in relation to a user. Pivoting arms 405a and 405b include a device configured to store potential energy and/or automatically raise/elevate the arms to first position 413 when at rest. This device may be described as first positioning member 417. Member 417 is configured to lift arms 405 from the second position 415 to the first position 413. These may be coupled to either the backrest 403 or panels 409. As seen in FIG. 10, member 417 is depicted as a mechanical spring configured to store potential energy as the arms are rotated into the second positions. The spring then releases the potential energy to raise the arm. The use of a member 417 is equally applicable to both mechanical operation and automated operation configurations of chair 400. The use of a spring as an example of member 417 is meant to be a nonlimiting example. Other devices may be used, such as electro-mechanical motors and actuators to name a few.

In automated operation configurations, chair 400 is configured to regulate the position of the arm as it moves out of the first position. As stated above, this may be done by various devices such as electro-mechanical motors and actuators as seen with member 417, however FIG. 10 illustrates the use of a second positioning member 419 which is configured to use air pressure. Member 419 includes an airbag 421 located between a brace 423 and an outer surface 425 of arm 405a. Brace 423 extends upward from panels 409 and/or backrest 403. Brace 423 is a rigidly formed member that is fastened to panels 409/backrest 403 to provide rigid support for airbag 421, such that inflation of airbag 421 causes pressure to be applied inward onto pivoting arm 405 to rotate it about axis 411a/411b. Brace 423 is acknowledged to be ideally inflexible but is also understood that some flexure is permitted as long as it does not inhibit proper functioning of pivoting arms 405.

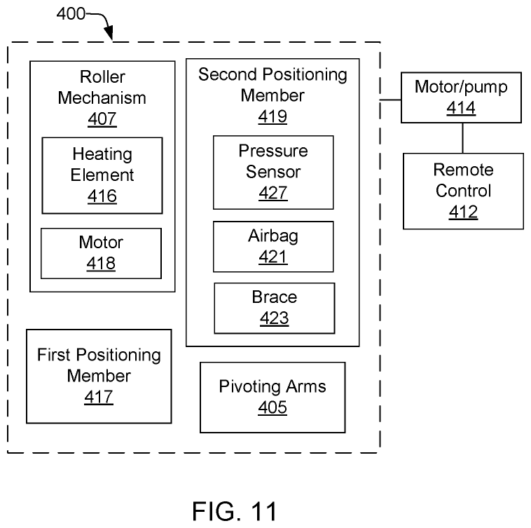

A motorized device (i.e. pump 414, see FIG. 11) within chair 400 is in fluid communication with airbag 421 and selectively pumps air into and out of airbag 421 to cause inflation and deflation thereof. The expanding size of airbag 421 induces a pressure or force upon member 417 which causes arm 405 to rotate out of the first position 413 into the second position 415. As air pressure is released from airbag 421, member 417 lifts arm 405 upwards toward the first position 413.

As seen in FIG. 10, airbags may also be found in the leg portion of the massage chair as denoted by airbags 421a. Airbags 421 may be similar in form and function to airbags 421.

Referring now also to FIG. 11 in the drawings, a chart of chair 400 is illustrated. Second positioning member 419 further includes a pressure sensor 427 in communication with airbag 421. Sensor 427 is configured to monitor the air pressure within airbag 421. In an automated operation configuration, arm 405 lowers automatically to a particular second position in relation to the user. It is known that users are different sized. The second position 415 is not dictated solely by a set position but may be determined in accordance with the size and preferences of the user.

For example, sensor 427 is configured to monitor the air pressure in airbag 421. Chair 400 may be configured to adjust the position of second position 415 in relation to a predetermined max air pressure as measured from sensor 427. It is an object of chair 400 to apply a selected pressure with arms 405 onto the user to allow for effective massaging, however it is not an object to cause discomfort, harm, or avoid any contact on the user. A user may use remote control 412 to select the level of pressure they prefer or may use a preset max setting within chair 400.

It is understood that airbag 421 may be used to regulate the movement and position of the arms as they also transition back toward the first position. This is seen at least in the speed in which the arms retract back to the first position. Additionally, remote control 412 may be used in combination with airbag 421 to adjust or reposition the arms during the massage.

Likewise, it should be understood that some embodiments may forgo the use of first positioning member 417, relying upon member 419 to fully regulate the position of the pivoting arms.

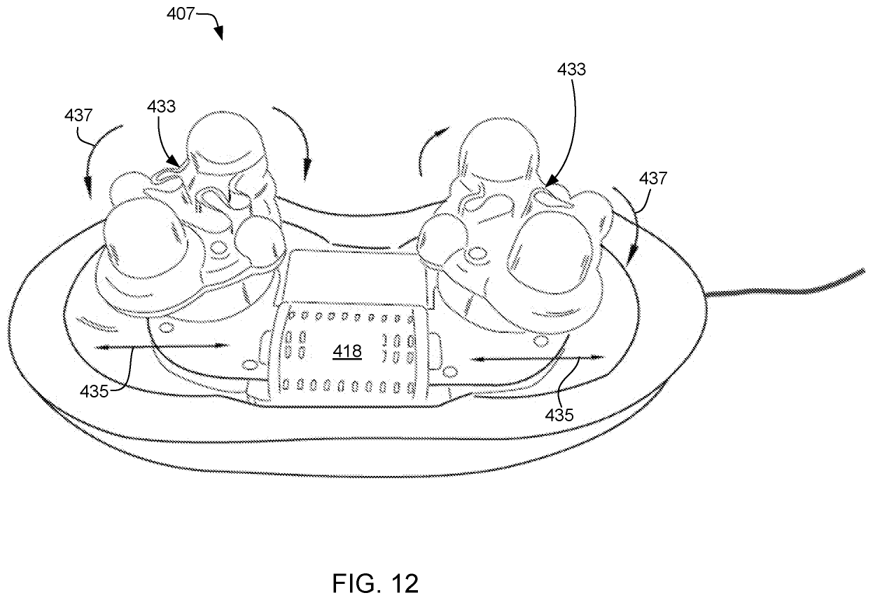

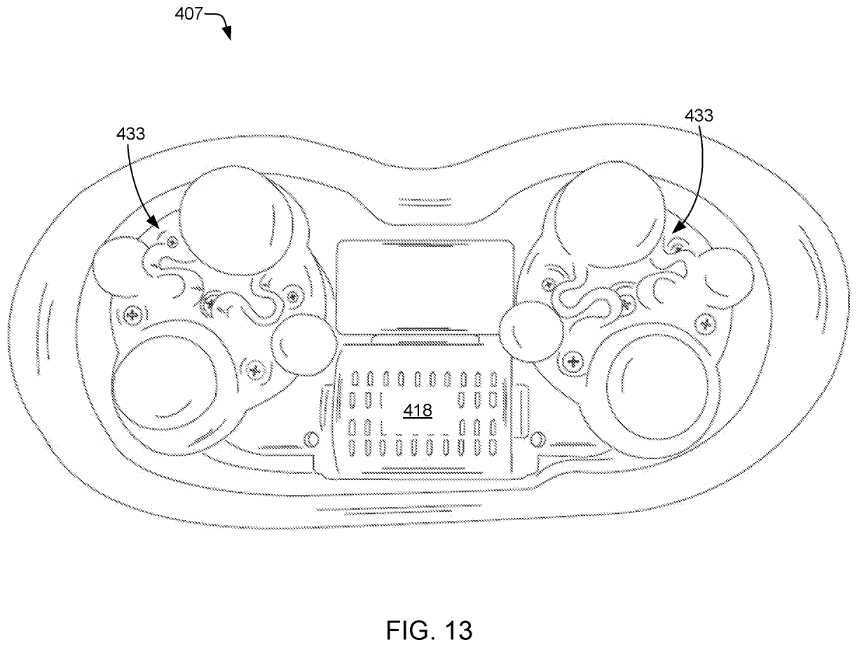

Referring now also to FIGS. 12 and 13 in the drawings, views of roller mechanism 407 is illustrated. As noted previously, each pivoting arm 405a and 405b includes at least one roller mechanism 407. Roller mechanism 407 is located along a lower surface 431 of arm 405a and 405b such that movement of rollers 433 engage the user in chair 400 so as to induce a massaging effect. Mechanism 407 permits rollers 433 to move in at least one of a rotational manner and a linear manner. As seen in particular with FIG. 12, arrows 435 depict exemplary linear movements of each roller 433. Likewise, arrows 437 depict exemplary rotations movements of each roller 433.

Roller mechanism 407 further includes a motor 418 configured to regulate the movement in accordance with a particular set program or a desired setting of the user. Motor 418 allows mechanism 407 to operate between a plurality of settings including settings that regulate at least any of the following: on/off function, rotational speed of rollers 433, linear motion settings of the rollers 433. Furthermore, roller mechanism 407 may further be configured to induce a temperature change sufficient to be felt by the user through surface 431. This temperature change could be either a cooling or heating change. Mechanism 407 may include a heating element 416 to assist with regulating temperature to the user. Operation of element 416 may be controlled through remote control 412.

As noted throughout with respect to FIGS. 9-13, the functional limitation and characteristics of pivoting arms 405a apply equally to pivoting arms 405b. Chair 400 may include either set of arms. Additionally, the purposes described herein are not limited to a pair of arms working together but may be fulfilled by a single arm. The arms are understood to be operable independently of one another if needed. Discussion related to the form and function of member 419 with respect to arms 405a apply to arms 405b, except that member 419 would be coupled to backrest 403 as opposed to a panel 409.

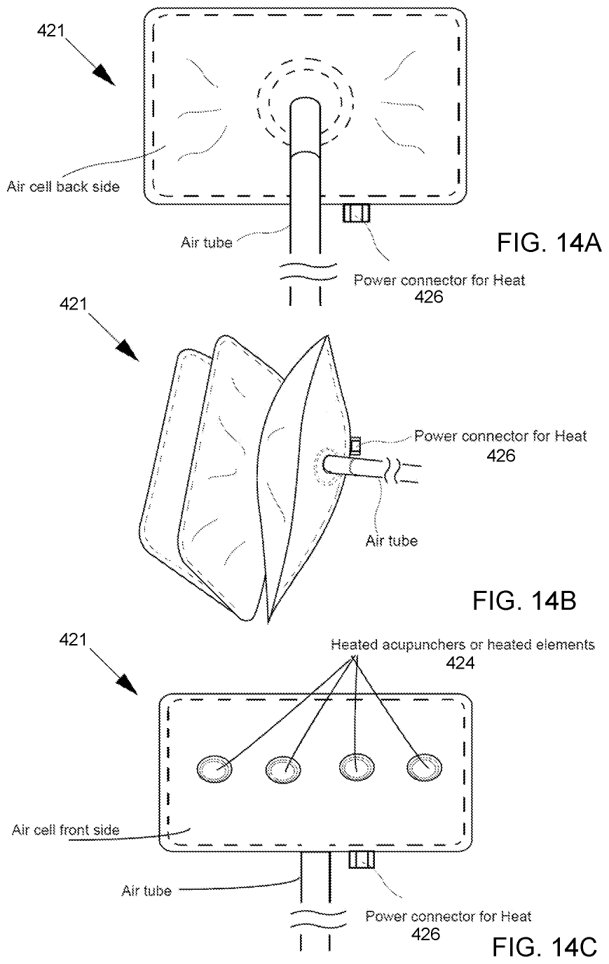

Referring now also to FIGS. 14A-14C in the drawings, enlarged views of airbag 421 are provided. Airbag 421 is configured to include an air tube that is in communication with pump 414 to selectively fill and evacuate air therein. Airbag 421 may optionally include heating elements 424 coupled to at least one surface of airbags 421. A power connector 426 may be included to route power from a power source to heating elements 424 to generate heat. As seen from the Figures, airbag 421 may consist of one or more individual airbags that operate together to actuate panels 405.

As seen in FIG. 9, chair 400 may include other massaging devices, such as a neck massaging device and leg massaging device. These may work in combination with the described embodiments to provide a full massage on all sides of a user. Additionally, it should be understood that the massage chairs disclosed in the present application are configured to produce heat throughout all surfaces in which a user would contact. For example, heat may be generated in the various portions of the seat such as the neck portion, upper back, lower back, seat, hands, legs (i.e. calves and feet), and so forth. The heat generation may be produced though the massage apparatus 100, device 170, and/or mechanism 407 wherein the actual devices inducing massage have heat capabilities (i.e. heating element) or wherein other heating elements are located within the body of the chair external to apparatus 100, device 170, and/or mechanism 407.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A massage chair, comprising:
a seat and a backrest configured to support a user;
a frame in communication with the seat and the backrest, the frame comprising a pair of guide rails and a pair of guide channels that are spaced apart to provide a balanced movement of a massage device along the pair of guide channels, each of said pair of guide rails comprises a curved portion located about the seat, backrest extending upward from the curved portion;
wherein each guide channel comprises a plurality of gear teeth that smoothly transitions from the backrest to the curved portion, the guide channel comprises at least two sections of a plurality of gear teeth that are coupled together via a joint, the joint running parallel to the plurality of gear teeth;
a pair of side panels extending upward from opposing sides of the seat; and
a pivoting arm coupled to at least one of the pair of side panels, the pivoting arm configured to rotate between a first position and a second position, the pivoting arm configured to extend over the seat in the second position so as to wrap around the user and provide a massaging effect to a front portion of a leg of the user.

2. The massage chair of claim 1, further comprising:
a brace coupled to at least one of the pair of side panels and adjacent to the pivoting arm.

3. The massage chair of claim 1, wherein the pivoting arm includes a first positioning member configured to automatically elevate the pivoting arm from the second position to the first position.

4. The massage chair of claim 1, further comprising: a spring a roller mechanism within the pivoting arm, the roller mechanism configured to selectively agitate a surface of the pivoting arm so as to induce a massage effect.

5. The massage chair of claim 3, further comprising:
a second positioning member configured to selectively lower the pivoting arm into the second position, the second positioning member configured to apply a force against the first positioning member.

6. The massage chair of claim 5, wherein the second positioning member is an airbag.

7. The massage chair of claim 1, further comprising:
a positioning member in communication with the pivoting arm, the positioning member being configured to selectively lower the pivoting arm into the second position.

8. The massage chair of claim 7, wherein the pivoting arm is configured to store potential energy as it moves into the second position, the potential energy being configured to selectively return the pivoting arm to the first position.

9. The massage chair of claim 7, wherein the positioning member is an airbag, the airbag configured to selectively inflate thereby inducing movement of the pivoting arm between the first position and the second position.

10. The massage chair of claim 9, wherein the positioning member includes a pressure sensor, the pressure sensor configured to monitor air pressure within the second positioning member.

11. The massage chair of claim 10, further comprising:
a remote control configured to regulate acceptable pressure levels through communication with the pressure sensor.

12. The massage chair of claim 10, wherein the position of the pivoting arm is determined in accordance with pressure levels detected through the pressure sensor.

13. The massage chair of claim 1, further comprising:
a remote control configured to regulate the operation of the roller mechanism.

14. The massage chair of claim 13, wherein the roller mechanism includes a plurality of settings to include at least one of an on and off setting, a rotational speed setting, and a motion setting.

15. The massage chair of claim 13, wherein the roller mechanism includes a setting to regulate the generation of heat.

16. A massage chair, comprising:
a seat and a backrest configured to support a user;
a frame in communication with the seat and the backrest, the frame comprising a pair of guide rails and a pair of guide channels that are spaced apart to provide a balanced movement of a massage device along the pair of guide channels, each of said pair of guide rails comprises a curved portion located about the seat, backrest extending upward from the curved portion;
wherein each guide channel comprises a plurality of gear teeth that smoothly transitions from the backrest to the curved portion, the guide channel comprises at least two sections of a plurality of gear teeth that are coupled together via a joint, the joint running parallel to the plurality of gear teeth;
a pair of side panels extending upward from opposing sides of the seat; and
a pivoting arm coupled to the backrest, the pivoting arm configured to rotate between a first position and a second position, the pivoting arm configured to extend over the backrest in the second position so as to wrap around the user and induce a massaging effect upon a front portion of the user.

17. The massage chair of claim 16, further comprising:
a brace coupled to the backrest and adjacent to the pivoting arm.

18. The massage chair of claim 16, wherein the pivoting arm includes a first positioning member configured to automatically elevate the pivoting arm from the second position to the first position.

19. The massage chair of claim 16, further comprising:
a roller mechanism within the pivoting arm, the roller mechanism configured to selectively agitate a surface of the pivoting arm so as to induce a massage effect.

20. The massage chair of claim 18, further comprising:
a second positioning member configured to selectively lower the pivoting arm into the second position, the second positioning member configured to apply a force against the first positioning member.

21. The massage chair of claim 20, wherein the second positioning member is an airbag.

22. The massage chair of claim 16, further comprising:
a second positioning member in communication with the pivoting arm, the second positioning member being configured to selectively lower the pivoting arm into the second position.

23. The massage chair of claim 22, wherein the pivoting arm is configured to store a potential energy as it moves into the second position, the potential energy being configured to selectively return the pivoting arm to the first position.

24. The massage chair of claim 22, wherein the second positioning member is an airbag, the airbag configured to selectively inflate thereby inducing movement of the pivoting arm between the first position and the second position.

25. The massage chair of claim 24, wherein the second positioning member includes a pressure sensor, the pressure sensor configured to monitor air pressure within the second positioning member.

26. The massage chair of claim 25, further comprising:
a remote control configured to regulate acceptable pressure levels through communication with the pressure sensor

27. The massage chair of claim 25, wherein the position of the pivoting arm is determined in accordance with pressure levels detected through the pressure sensor.

28. The massage chair of claim 16, further comprising:
a remote control configured to regulate the operation of the roller mechanism.

29. The massage chair of claim 28, wherein the roller mechanism includes a plurality of settings to include at least one of an on and off setting, a rotational speed setting, and a motion setting.

30. The massage chair of claim 28, wherein the roller mechanism includes a setting to regulate the generation of heat.
